(19) United States
(12) Patent Application Publication
(10) Pub. No.: US 2023/0098836 A1
(43) Pub. Date: Mar. 30, 2023

(54) RECHARGEABLE LITHIUM BATTERY

(71) Applicant: SAMSUNG SDI CO., LTD., Yongin-si (KR)

(72) Inventors: Seungryong OH, Yongin-si (KR); Myunghoon KIM, Yongin-si (KR); Sanghoon KIM, Yongin-si (KR); Yunhee KIM, Yongin-si (KR); Injun PARK, Yongin-si (KR); Hongryeol PARK, Yongin-si (KR); Jeongmin SHIN, Yongin-si (KR); Myunghwan JEONG, Yongin-si (KR); Hyunbong CHOI, Yongin-si (KR)

(21) Appl. No.: 17/893,014

(22) Filed: Aug. 22, 2022

(30) Foreign Application Priority Data
Aug. 26, 2021 (KR) 10-2021-0113344
May 19, 2022 (KR) 10-2022-0061566

(51) Int. Cl. H01M 10/0567; H01M 10/0525; H01M 4/583; H01M 4/505; H01M 4/525; H01M 4/485; H01M 10/0568; H01M 4/36; H01M 4/38

(52) U.S. Cl. CPC H01M 10/0567; H01M 10/0525; H01M 4/583; H01M 4/505; H01M 4/525; H01M 4/485; H01M 10/0568; H01M 4/366; H01M 4/386; H01M 2004/027

(57) ABSTRACT

A rechargeable lithium battery includes a positive electrode including a positive active material; a negative electrode including a negative active material; and an electrolyte solution including a non-aqueous organic solvent, a lithium salt, and an additive, wherein the negative active material includes a Si composite and the additive includes a compound represented by Chemical Formula 1.

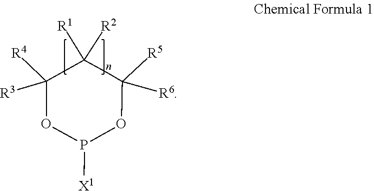

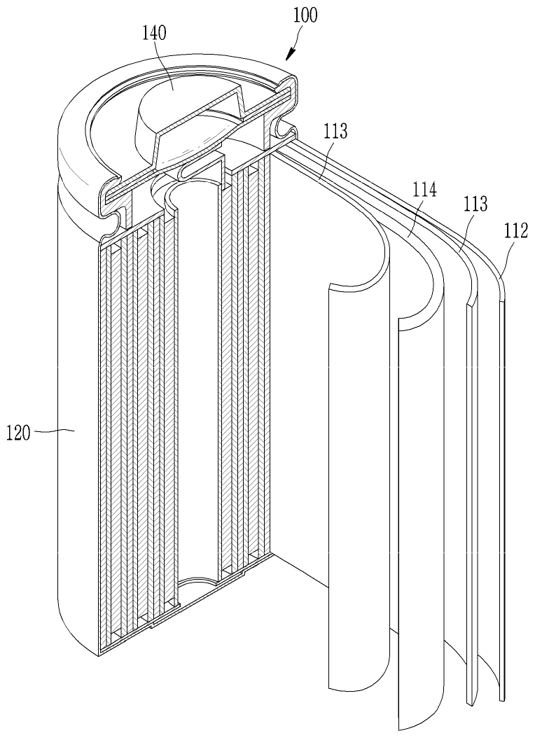

Details of Chemical Formula 1 are as described in the specification.

### CROSS-REFERENCE TO RELATED APPLICATION

This application claims priority to and the benefit of Korean Patent Application No. 10-2021-0113344, filed in the Korean Intellectual Property Office on Aug. 26, 2021, and Korean Patent Application No. 10-2022-0061566, filed in the Korean Intellectual Property Office on May 19, 2022, the entire contents of both of which are incorporated herein by reference.

### BACKGROUND

### 1. Field

This disclosure relates to a rechargeable lithium battery.

### 2. Description of the Related Art

A rechargeable lithium battery may be recharged and may have an energy density per unit weight as high as three or more times that of a related art lead storage (or lead acid) battery, nickel-cadmium battery, nickel hydrogen battery, nickel zinc battery and/or the like. It may also be charged at a high charging rate and thus, may be suitable (e.g., commercially manufactured) for a laptop, a cell phone, an electric tool, an electric bike, and/or the like. Researches, e.g., on improvement of energy density, have been actively conducted.

For example, as information technology (IT) devices increasingly (e.g., continuously) achieve higher performance, a high-capacity battery is desired or required. While the high capacity may be realized through expansion of a voltage range, increasing the energy density may cause a problem of deteriorating performance of a positive electrode due to oxidization of an electrolyte solution in the high voltage range.

For example, LiPF₆, which is commonly (e.g., most often) utilized as a lithium salt of the electrolyte solution, may react with an electrolyte solvent to promote (or cause) depletion of the solvent and generate a large amount of gas. LiPF₆ may be decomposed and produce a decomposition product such as HF, PFS, and/or the like, which may cause the electrolyte depletion and lead to performance deterioration and insufficient safety at a high temperature.

The decomposition products of the electrolyte solution may be deposited as a film on the surface of an electrode to increase internal resistance of the battery and eventually may cause problems of deteriorated battery performance and shortened cycle-life. In addition, this side reaction is further accelerated at a high temperature where the reaction rate becomes faster, and gas components generated due to the side reaction may cause a rapid increase of an internal pressure of the battery and thus may have a strong adverse effect on the stability of the battery.

Oxidization of the electrolyte solution is accelerated (e.g., greatly accelerated) in the high voltage range and thus is known to greatly increase the resistance of the electrode during the long-term charge and discharge process.

Accordingly, there is a need for an electrolyte solution suitable for usage under conditions of a high voltage and a high-temperature.

### SUMMARY

Aspects according to one or more embodiments are directed toward a rechargeable lithium battery having improved battery stability and at the same time improved cycle-life characteristics according to an increase in capacity, in which when a negative active material including a silicon (Si) composite is utilized for high capacity, an increase in internal resistance of a battery due to a side reaction between Si particles and an electrolyte solution may be suppressed by introduction of an additive.

Additional aspects will be set forth in part in the description which follows and, in part, will be apparent from the description, or may be learned by practice of the presented embodiments of the disclosure.

According to an embodiment of the present disclosure, a rechargeable lithium battery includes a positive electrode including a positive active material; a negative electrode including a negative active material; and an electrolyte solution including a non-aqueous organic solvent, a lithium salt, and an additive,

wherein the negative active material includes a Si composite, and

the additive includes a compound represented by Chemical Formula 1.

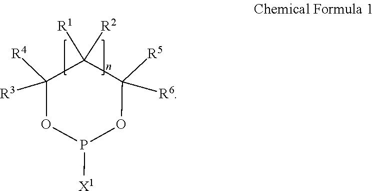

In Chemical Formula 1,

X¹ is a fluoro group (—F), a chloro group (—Cl), a bromo group (—Br), or an iodo group (—I),

R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and

n is 0 or 1.

The compound represented by Chemical Formula 1 may include a compound represented by Chemical Formula 1A or Chemical Formula 1B.

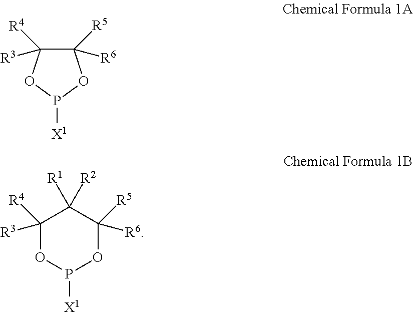

In Chemical Formula 1A and Chemical Formula 1B,

X¹ is a fluoro group (—F), a chloro group (—Cl), a bromo group (—Br), or an iodo group (—I), and

R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In Chemical Formula 1A, R³ and R⁴ may each be hydrogen, and R⁵ and/or R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

The compound represented by Chemical Formula 1 may be about 0.1 parts by weight to about 10 parts by weight in amount based on 100 parts by weight of the electrolyte solution.

The compound represented by Chemical Formula 1 may be selected from compounds of Group 1.

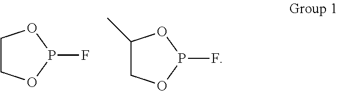

The additive may further include at least one other additive selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

The Si composite may include a core including Si-based particles and an amorphous carbon.

The core including the Si-based particles may include at least one selected from among Si particles, a Si—C composite, SiOₓ (0<x≤2), and a Si alloy.

The Si—C composite may include Si particles and an amorphous carbon.

A void may be included in the center portion of the core.

A radius of the center portion may correspond to about 30% to about 50% of a radius of the negative active material, and an average particle diameter of the Si particles may be about 10 nm to about 200 nm.

The center portion does not include any amorphous carbon, and the amorphous carbon may be present only in a surface portion of the negative active material.

The negative active material may further include graphite.

The amorphous carbon may include soft carbon, hard carbon, mesophase pitch carbide, calcined coke, or a mixture thereof.

The positive active material may be at least one lithium composite oxide represented by Chemical Formula 3.

LiₓM¹_{y}M²_{z}M³_{1-y-z}O₂₋ₐXₐ Chemical Formula 3

In Chemical Formula 3,

0.5≤x≤1.8, 0≤a≤0.05, 0≤y≤1, 0≤z≤1, 0≤y+z≤1, M¹, M², and M³ are each independently selected from the group consisting of Ni, Co, Mn, Al, B, Ba, Ca, Ce, Cr, Fe, Mo, Nb, Si, Sr, Mg, Ti, V, W, Zr, La, and a combination thereof, and X is at least one element selected from the group consisting of F, S, P, and Cl.

In Chemical Formula 3, 0.8≤y≤1, 0≤z≤0.2, and M¹ may be Ni.

In view of the above and as discussed in more detail below, an increase in the internal resistance of the battery may be suppressed and a rechargeable lithium battery with improved cycle-life characteristics may be realized.

### BRIEF DESCRIPTION OF THE DRAWING

The drawing is a schematic view illustrating a rechargeable lithium battery according to an embodiment of the present disclosure.

### DETAILED DESCRIPTION

Hereinafter, a rechargeable lithium battery according to embodiments of the present disclosure will be described in more detail with reference to the accompanying drawing. However, these embodiments are examples, the present disclosure is not limited thereto and the present disclosure is defined by the scope of claims, and equivalents thereof.

Hereinafter, when a definition is not otherwise provided, “substituted” refers to replacement of hydrogen of a compound by a substituent selected from a halogen atom (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, and a combination thereof.

A rechargeable lithium battery may be classified into a lithium ion battery, a lithium ion polymer battery, and a lithium polymer battery depending on the type(s) or kind(s) of a separator and an electrolyte, and may also be classified to be cylindrical, prismatic, coin-type or kind, pouch-type or kind, and/or the like depending on the shape(s). In addition, a rechargeable lithium battery may be a bulk type or kind, thin film type or kind, depending on the size(s). Structures and manufacturing methods for these batteries pertaining to this disclosure may be any suitable ones in the related art.

Herein, a cylindrical rechargeable lithium battery will be described as an example of the rechargeable lithium battery. The drawing schematically shows the structure of a rechargeable lithium battery according to an embodiment. Referring to the drawing, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte solution impregnating the positive electrode 114, the negative electrode 112, and the separator 113, a battery case 120 housing the battery cell, and a sealing member 140 sealing the battery case 120.

Hereinafter, a more detailed configuration of the rechargeable lithium battery 100 according to an embodiment of the present disclosure will be described.

A rechargeable lithium battery according to an embodiment of the present disclosure includes a positive electrode, a negative electrode, and an electrolyte solution.

The electrolyte solution includes a non-aqueous organic solvent, a lithium salt, and an additive, and the additive includes a compound represented by Chemical Formula 1.

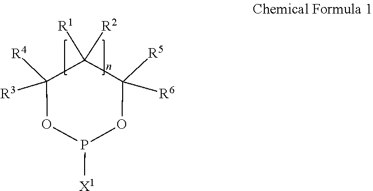

In Chemical Formula 1,

X¹ is a fluoro group (—F), a chloro group (—Cl), a bromo group (—Br), or an iodo group (—I),

R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and

n is 0 or 1.

The compound represented by Chemical Formula 1 has suitable or high high-temperature stability on the surface of the negative electrode, forms a solid electrolyte interface (SEI) with suitable or excellent ion conductivity, and suppresses a side reaction of LiPF₆ by a functional group such as —PO₂X¹ (especially —PO₂F) to reduce the gas generation caused by a decomposition reaction of the electrolyte solution during high-temperature storage.

For example, as to be described in more detail later, when a Si composite including Si particles is utilized as a negative active material for (e.g., to provide) high capacity, an internal resistance of the battery increases due to a side reaction between the Si particles and the electrolyte solution, and as the content of Si particles increases, a degree of increase (e.g., the amount of increase) in the internal resistance is even higher.

However, when the compound represented by Chemical Formula 1 is introduced (e.g., included) as an additive, the side reaction between the Si particles and the electrolyte solution may be suppressed and thus a rechargeable lithium battery with improved battery stability and improved cycle-life characteristics according to capacity increase may be provided. That is, it is possible to further improve on the trade-off characteristics of an increase in capacity and an increase in resistance, which may occur when Si particles are utilized.

For example, the compound represented by Chemical Formula 1 may be coordinated with a pyrolyzed product of a lithium salt such as LiPF₆ or anion(s) dissociated from the lithium salt and thus form a complex, and the complex formation may stabilize the pyrolyzed product of the lithium salt such as LiPF₆ or the anion(s) dissociated from the lithium salt. Therefore, it may suppress an undesired side reaction of the anions with the electrolyte and prevent or reduce gas generation inside a rechargeable lithium battery, and thus may greatly reduce a defect rate as well as improve cycle-life characteristics of the rechargeable lithium battery.

For example, the 5-membered or 6-membered phosphorus heterocycles (represented by Formula 1) contributes to the stabilization of anions dissociated from the pyrolyzed product of the lithium salt or the lithium salt due to the formation of the complex, whereas a related art linear phosphite derivative induces a side reaction of LiPF₆ due to the dissociated —PO₂X¹ (especially —PO₂F) functional group and causes gas generation due to the decomposition reaction of the electrolyte when stored at high temperature. Therefore, when the compound represented by Chemical Formula 1 includes the 5-membered or 6-membered phosphorus heterocycles is included compared to a related art linear phosphite derivative, cycle-life characteristics of the rechargeable lithium battery may be more remarkably improved.

The compound represented by Chemical Formula 1 may be represented by Chemical Formula 1A or Chemical Formula 1B.

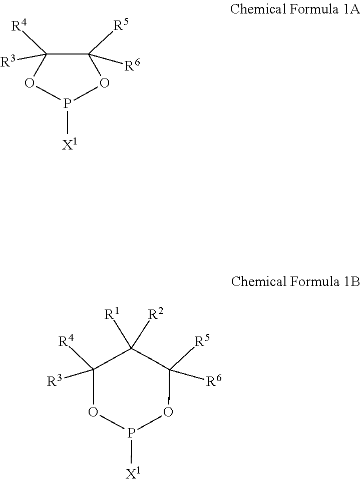

In Chemical Formula 1A and Chemical Formula 1B,

X¹ is a fluoro group (—F), a chloro group (—Cl), a bromo group (—Br), or an iodo group (—I), and

R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In Chemical Formula 1A and Chemical Formula 1B, R³ and R⁴ may each be hydrogen, and at least one selected from among R¹, R², R⁵, and R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, the compound represented by Chemical Formula 1 may be represented by Chemical Formula 1A.

In an embodiment, in Chemical Formula 1A, R³ and R⁴ may each be hydrogen and R⁵ and/or R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, in Chemical Formula 1A, R³ and R⁴ may each be hydrogen and R⁵ and/or R⁶ may be a substituted or unsubstituted C1 to C10 alkyl group.

The compound represented by Chemical Formula 1 may be included in an amount of about 0.1 parts by weight to 10 parts by weight, for example about 0.1 parts by weight to about 5.0 parts by weight, or about 0.1 parts by weight to about 3.0 parts by weight based on 100 parts by weight of the electrolyte solution.

When the amount of the compound represented by Chemical Formula 1 is within the above ranges, a rechargeable lithium battery having improved high-temperature storage characteristics and cycle-life characteristics can be obtained (e.g., implemented).

For example, the compound represented by Chemical Formula 1 may be selected from the compounds of Group 1, and may be, for example, 2-fluoro-1,3,2-dioxaphospholane and/or 2-fluoro-4-methyl-1,3,2-dioxaphospholane.

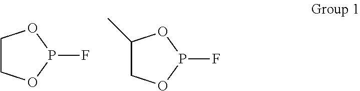

In some embodiments, the additive may further include other additive(s) in addition to the aforementioned additive.

The other additive(s) may include at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), polysulfone, 1,3,6-hexane tricyanide (HTCN), propene sultone (PST), propane sultone (PS), lithium tetrafluoroborate (LiBF₄), lithium difluorophosphate (LiPO₂F₂), and 2-fluorobiphenyl (2-FBP).

By further including the aforementioned other additive(s), cycle-life may be further improved and/or gases generated from the positive electrode and the negative electrode may be effectively controlled during high-temperature storage.

The other additive(s) may be included in an amount of about 0.2 parts by weight to about 20 parts by weight, for example, about 0.2 parts by weight to about 15 parts by weight, or about 0.2 parts by weight to about 10 parts by weight based on the total weight of the electrolyte solution for a rechargeable lithium battery.

When the content of other additive(s) is as described above, the increase in film resistance may be minimized or reduced, thereby contributing to the improvement of battery performance.

The non-aqueous organic solvent serves as a medium for transmitting ions taking part in the electrochemical reaction of a battery.

The non-aqueous organic solvent may be a ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, t-butyl acetate, methylpropionate, ethylpropionate, propylpropionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In addition, the ketone-based solvent may include cyclohexanone, and/or the like. The alcohol-based solvent may include ethanol, isopropyl alcohol, and/or the like and the aprotic solvent may include nitriles such as R—CN (wherein R is a hydrocarbon group having a C2 to C20 linear, branched, or cyclic structure and may include a double bond, an aromatic ring, or an ether bond), and/or the like, amides such as dimethyl formamide, and/or the like, dioxolanes such as 1,3-dioxolane, and/or the like, sulfolanes, and/or the like.

The non-aqueous organic solvent may be utilized alone or in a mixture, and when the non-aqueous organic solvent is utilized in a mixture, the mixing ratio may be controlled in accordance with a desirable battery performance.

The carbonate-based solvent may be prepared by mixing a cyclic carbonate and a linear carbonate. When the cyclic carbonate and linear carbonate are mixed together in a volume ratio of about 5:5 to about 1:9, an electrolyte performance may be improved.

In an embodiment, the non-aqueous organic solvent may include the cyclic carbonate and the linear carbonate in a volume ratio of about 5:5 to about 2:8, for example, the cyclic carbonate and the linear carbonate may be included in a volume ratio of about 4:6 to about 2:8.

In an embodiment, the cyclic carbonate and the linear carbonate may be included in a volume ratio of about 3:7 to about 2:8.

The non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound represented by Chemical Formula 2.

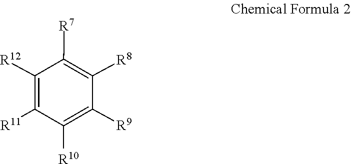

In Chemical Formula 2, R⁷ to R¹² are the same or different and are each independently selected from hydrogen, a halogen, a C1 to C10 alkyl group, a C1 to C10 haloalkyl group, and a combination thereof.

Examples of the aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The lithium salt dissolved in the non-aqueous organic solvent supplies lithium ions in a battery, enables a basic operation of a rechargeable lithium battery, and improves transportation of the lithium ions between positive and negative electrodes. Examples of the lithium salt may include at least one supporting salt selected from LiPF₆, LiBF₄, lithium difluoro(oxalato)borate (LiDFOB), LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiN(CₓF₂ₓ₊₁SO₂)(C_{y}F_{2y+1}SO₂), (wherein, x and y are natural numbers, for example, an integer ranging from 1 to 20), LiCl, LiI, and LiB(C₂O₄)₂ (lithium bis(oxalato) borate, LiBOB). The lithium salt may be utilized in a concentration ranging from about 0.1 M to about 2.0 M. When the lithium salt is included at the above concentration range, an electrolyte may have suitable or excellent performance and lithium ion mobility due to optimal electrolyte conductivity and viscosity.

The positive electrode includes a positive electrode current collector and a positive active material layer on the positive electrode current collector, and the positive active material layer includes a positive active material.

The positive active material may include lithiated intercalation compounds that reversibly intercalate and de-intercalate lithium ions.

For example, a composite oxide of a nickel-containing metal and lithium may be utilized.

Examples of the positive active material may include a compound represented by any one of the following chemical formulas.

LiₐA_{1-b}X_{b}D₂ (0.90≤a≤1.8, 0≤ b≤ 0.5); LiₐA_{1-b}X_{b}O_{2-c}D_{c} (0.90≤ a≤ 1.8, 0≤ b≤0.5, 0≤c≤0.05); LiₐE_{1-b}X_{b}O_{2-c}D_{c} (0.90≤a≤1.8, 0≤b≤0.5, 0≤c≤ 0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α}(0.90≤a≤1.8, 0≤b≤0.5, 0≤c≤0.5, 0<α≤2); LiₐNi_{1-b-c}Co_{b}X_{c}O_{2-α}T_{α}(0.90≤a≤1.8, 0≤b≤0.5, 0≤c≤0.05, 0<α<2); LiₐNi_{1-b-c}Co_{b}X_{c}O_{2-α}T₂ (0.90≤ a≤ 1.8, 0≤ b≤ 0.5, 0≤ c≤ 0.05, 0<α<2); LiₐNi_{1-b-c}Mn_{b}X_{c}D_{α}(0.90≤ a≤ 1.8, 0≤ b≤ 0.5, 0≤ c≤ 0.05, 0<α≤ 2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂(0.90≤a≤ 1.8, 0≤b≤0.9, 0≤c≤0.5, 0.001≤d≤0.1); LiₐNi_{b}Co_{c}Mn_{d}GₑO₂(0.90≤a≤1.8, 0≤b≤0.9, 0≤c≤0.5, 0≤d≤0.5, 0.001≤ e≤ 0.1); LiₐNiG_{b}O₂ (0.90≤ a≤ 1.8, 0.001≤ b≤ 0.1); LiₐCoG_{b}O₂ (0.90≤ a≤ 1.8, 0.001≤ b≤ 0.1); LiₐMn_{1-b}G_{b}O₂ (0.90≤ a≤ 1.8, 0.001≤ b≤ 0.1); LiₐMn₂G_{b}O₄ (0.90≤ a≤1.8, 0.001≤ b≤ 0.1); LiₐMn_{1-g}G_{g}PO₄ (0.90≤ a≤ 1.8, 0≤ g≤ 0.5); QO₂; QS₂; LiQS₂; V₂O₅; LiV₂O₅; LiZO₂; LiNiVO₄; Li_{(3-f}J₂(PO₄)₃ (0≤ f≤ 2); Li_{(3-f)}Fe₂(PO₄)₃ (0≤ f≤ 2); LiₐFePO₄ (0.90≤a≤1.8)

In the above chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface thereof, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating process may include any suitable related art processes as long as it does not cause any side effects on the properties of the positive active material (e.g., spray coating, dipping, etc.), which should be well known to persons having ordinary skill in this art, so a detailed description thereof is not provided.

The positive active material may be, for example, at least one lithium composite oxide represented by Chemical Formula 3.

LiₓM¹_{y}M²_{z}M³_{1-y-z}O₂₋ₐXₐ Chemical Formula 3

In Chemical Formula 3,

0.5≤x≤1.8, 0≤a≤0.05, 0≤y≤1, 0≤z≤1, 0≤y+z≤1, M¹, M², and M³ are each independently selected from the group consisting of Ni, Co, Mn, Al, B, Ba, Ca, Ce, Cr, Fe, Mo, Nb, Si, Sr, Mg, Ti, V, W, Zr, La, and a combination thereof, and X is at least one element selected from the group consisting of F, S, P, and Cl.

In an embodiment, the positive active material may be at least one selected from the group consisting of LiCoO₂, LiNiO₂, LiMnO₂, LiMn₂O₄, LiNiₐMn_{b}Co_{c}O₂ (a+b+c=1), LiNiₐMn_{b}Co_{c}Al_{d}O₂ (a+b+c+d=1), and LiNiₑCo_{f}Al_{g}O₂ (e+f+g=1).

In an embodiment, in Chemical Formula 3, 0.8≤y≤1, 0≤z≤0.2, and M¹ may be Ni.

For example, in the case of (e.g., when the positive active material is) LiNiₐMn_{b}Co_{c}O₂ (a+b+c=1) and LiNiₐMn_{b}Co_{c}Al_{d}O₂ (a+b+c+d=1), the nickel content may be greater than or equal to about 60% (a≥ 0.6), or, greater than or equal to about 80% (a≥0.8).

For example, in the case of (e.g., when the positive active material is) LiNiₑCo_{f}Al_{g}O₂ (e+f+g=1), the nickel content may be greater than or equal to about 60% (e≥0.6), or, greater than or equal to about 80% (e≥ 0.8).

In a more specific embodiment, the positive active material may be a lithium composite oxide represented by any one of Chemical Formula 3-1 to Chemical Formula 3-3.

Liₓ₁Ni_{y1}Co_{z1}Al_{1-y1-z1}O₂ Chemical Formula 3-1

In Chemical Formula 3-1, 1≤x1≤1.2, 0<y1<1, and 0<z1<1.

Liₓ₂Ni_{y2}Co_{z2}Mn_{1-y2-z2}O₂ Chemical Formula 3-2

In Chemical Formula 3-2,

1≤x2≤1.2, 0<y2<1, and 0<z2<1.

Liₓ₃CoO₂ Chemical Formula 3-3

In Chemical Formula 3-3,

0.5<x3≤1.

For example, in Chemical Formula 3-1, 1≤x1≤1.2, 0.5≤y1≤1, and 0<z1≤0.5.

In an embodiment, in Chemical Formula 3-1, 1≤x1≤1.2, 0.6≤y1<1, and 0<z1≤0.5.

In an embodiment, in Chemical Formula 3-1, 1≤x1≤1.2, 0.7≤y1<1, and 0<z1≤0.5.

For example, in Chemical Formula 3-1, 1≤x1≤1.2, 0.8≤y1<1, and 0<z1≤0.5.

For example, in Chemical Formula 3-2, 1≤x2≤1.2, 0.3≤y2<1, and 0.3≤z2<1.

In an embodiment, in Chemical Formula 3-2, 1≤x2≤1.2, 0.6≤y2<1, and 0.3≤z2<1.

In an embodiment, in Chemical Formula 3-2, 1≤x2≤1.2, 0.7≤y2<1, and 0.3≤z2<1.

For example, in Chemical Formula 3-2, 1≤x2≤1.2, 0.8≤y2<1, and 0.3≤z2<1.

A content of the positive active material may be about 90 wt % to about 98 wt % based on the total weight of the positive active material layer.

In an embodiment of the present disclosure, the positive active material layer may include a binder. A content of the binder may be about 1 wt % to about 5 wt % based on the total weight of the positive active material layer.

The binder improves binding properties of positive active material particles with one another and with a current collector. Examples thereof may include (e.g., may be) polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

Al may be utilized as the positive electrode current collector, but the present disclosure is not limited thereto.

The negative active material according to an embodiment may include a Si composite.

The Si composite may include a core including one or more Si-based particles and an amorphous carbon coating layer. For example, the core may include Si-based particles and an amorphous carbon, for example Si-based particles may include at least one selected from among a Si—C composite, SiOₓ(0<x≤2), and a Si alloy.

For example, the Si—C composite may include Si particles and a crystalline carbon.

A void may be included in the center portion of the core (e.g., the center portion of the core may be porous or hollow), and the radius of the center portion may correspond to about 30% to about 50% of the radius of the negative material.

An average particle diameter of the Si-based particles may be about 10 nm to about 200 nm.

In the present specification, the average particle diameter may be a particle size (D50) at 50% by volume in a cumulative size-distribution curve. For example, the average particle diameter may be, for example, a median diameter (D50) measured utilizing a laser diffraction particle diameter distribution meter.

When the average particle diameter of the Si particles is within the above range, volume expansion during charging and discharging may be suppressed, and a break in a conductive path due to particle crushing during charging and discharging may be prevented or reduced.

In the Si—C composite, Si particles may be included in an amount of about 1 wt % to about 60 wt %, for example, about 3 wt % to about 60 wt %, based on the total weight of the negative active material.

The center portion does not include any amorphous carbon, and the amorphous carbon may be present only in the surface portion of the negative active material (e.g., as a surface coating over the core).

In this case, the surface portion refers to a region from the outermost surface of the center portion to the outermost surface of the negative active material.

In addition, the Si particles are substantially uniformly included in the negative active material as a whole, that is, may be present in a substantially uniform concentration in the center portion and the surface portion.

The amorphous carbon may be soft carbon, hard carbon, a mesophase pitch carbonized product, calcined coke, or a combination thereof.

The crystalline carbon may be graphite, and more specifically may include natural graphite, artificial graphite, or a mixture thereof.

The negative active material may further include graphite.

When the negative active material includes the Si—C composite and the graphite together, the Si—C composite and the graphite may be included in the form of a mixture, in which the Si—C composite and the graphite may be included in a weight ratio of about 1:99 to about 50:50. For example, the Si—C composite and the graphite may be included in a weight ratio of about 3:97 to about 20:80 or about 5:95 to about 20:80.

The graphite may be, for example, graphite, such as natural graphite, artificial graphite, or a mixture thereof.

An average particle diameter of the graphite may be about 5 μm to about 30 μm.

The amorphous carbon precursor (e.g., for the amorphous carbon included in the Si—C composite) may include a coal-based pitch, mesophase pitch, petroleum-based pitch, coal-based oil, petroleum-based heavy oil, and/or a polymer resin such as a phenol resin, a furan resin, and/or a polyimide resin.

In the negative active material layer, the negative active material may be included in an amount of about 95 wt % to about 99 wt % based on the total weight of the negative active material layer.

In an embodiment of the present disclosure, the negative active material layer includes a binder, and optionally a conductive material. In the negative active material layer, a content of the binder may be about 1 wt % to about 5 wt % based on the total weight of the negative active material layer. When the negative active material layer includes a conductive material, the negative active material layer includes about 90 wt % to about 98 wt % of the negative active material, about 1 wt % to about 5 wt % of the binder, and about 1 wt % to about 5 wt % of the conductive material.

The binder improves binding properties of negative active material particles with one another and with a current collector. The binder may include a non-water-soluble binder, a water-soluble binder, or a combination thereof.

The non-water-soluble binder may be selected from polyvinylchloride, carboxylated polyvinylchloride, polyvinylfluoride, polyurethane, polytetrafluoroethylene, polyvinylidene fluoride, polyethylene, polypropylene, polyamideimide, polyimide, and a combination thereof.

The water-soluble binder may be a rubber-based binder and/or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylenecopolymer, polyethyleneoxide, polyvinylpyrrolidone, polyepichlorohydrine, polyphosphazene, polyacrylonitrile, polystyrene, an ethylenepropylenediene copolymer, polyvinylpyridine, chlorosulfonated polyethylene, latex, a polyester resin, an acrylic resin, a phenolic resin, an epoxy resin, polyvinyl alcohol, and a combination thereof.

When the water-soluble binder is utilized as a negative electrode binder, a cellulose-based compound may be further utilized to provide (e.g., modify) viscosity as a thickener. The cellulose-based compound includes one or more selected from among carboxymethyl cellulose, hydroxypropylmethyl cellulose, methyl cellulose, and alkali metal salts thereof. The alkali metals may be Na, K, and/or Li. Such a thickener may be included in an amount of about 0.1 parts by weight to about 3 parts by weight based on 100 parts by weight of the negative active material.

The conductive material is included to provide electrode conductivity and any suitable electrically conductive material may be utilized as a conductive material unless it causes a chemical change. Examples of the conductive material may include a carbon-based material such as natural graphite, artificial graphite, carbon black, acetylene black, ketjen black, a carbon fiber, and/or the like; a metal-based material including a metal powder and/or a metal fiber including copper, nickel, aluminum silver, and/or the like; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

A separator may be present (e.g., included) between the positive electrode and the negative electrode depending on the type or kind of the rechargeable lithium battery. Such a separator may include polyethylene, polypropylene, or polyvinylidene fluoride, or multi-layers thereof such as a polyethylene/polypropylene double-layered separator, a polyethylene/polypropylene/polyethylene triple-layered separator, or a polypropylene/polyethylene/polypropylene triple-layered separator.

Hereinafter, examples of the present disclosure and comparative examples are described. These examples, however, are not in any sense to be interpreted as limiting the scope of the present disclosure.

Manufacture of Rechargeable Lithium Battery Cell

### Example 1

LiNi_{0.88}Co_{0.105}Al_{0.015}O₂ as a positive active material, polyvinylidene fluoride as a binder, and carbon nanotubes (average length: 50 μm) as a conductive material were mixed in a weight ratio of 96:3:1, respectively, and were dispersed in N-methyl pyrrolidone to prepare a positive active material slurry.

The positive active material slurry was coated on a 20 μm-thick Al foil, dried at 100° C., and then pressed to prepare a positive electrode.

As a negative active material, a mixture of artificial graphite and a Si—C composite in a weight ratio of 93:7 was utilized, and the negative active material, a styrene-butadiene rubber binder, and carboxymethyl cellulose were mixed in a weight ratio of 98:1:1, respectively, and dispersed in distilled water to prepare a negative active material slurry.

The Si—C composite included a core including artificial graphite and silicon particles, and a coal-based pitch coating on the surface of the core. In this case, the silicon content was utilized in an amount of about 1.0 wt % based on the total weight of the negative active material.

The negative active material slurry was coated on a 10 μm-thick Cu foil, dried at 100° C., and then pressed to prepare a negative electrode.

An electrode assembly was prepared by assembling the prepared positive and negative electrodes and a polyethylene separator having a thickness of 25 μm, and an electrolyte solution was injected thereto to prepare a rechargeable lithium battery cell.

Composition of the electrolyte solution is as follows.

Lithium Salt: 1.5 M LiPF₆

Non-aqueous Organic Solvent: ethylene carbonate: ethylmethyl carbonate: dimethyl carbonate (EC:EMC:DMC=20:10:70 in a volume ratio)

Additive: 0.1 parts by weight of 2-fluoro-4-methyl-1,3,2-dioxaphospholane, 10 parts by weight of fluoroethylene carbonate (FEC), and 0.5 parts by weight of succinonitrile (SN). That is, the additives include 0.1 parts by weight of 2-fluoro-4-methyl-1,3,2-dioxaphospholane as the additive according to embodiments of the present disclosure, and further include 10 parts by weight of fluoroethylene carbonate (FEC) and 0.5 parts by weight of succinonitrile (SN) as the other additives.

Herein, in the composition of electrolyte solution, the term “parts by weight” refers to the relative content of additive(s) to 100 parts by weight of the total electrolyte solution excluding additives (lithium salt+non-aqueous organic solvent).

### Comparative Example 1

A rechargeable lithium battery cell was manufactured in substantially the same manner as in Example 1, except that an electrolyte solution including no 2-fluoro-4-methyl-1,3,2-dioxaphospholane and a negative electrode including no silicon particles were utilized.

### Comparative Example 2

A rechargeable lithium battery cell was manufactured in substantially the same manner as in Example 1, except that an electrolyte solution including no 2-fluoro-4-methyl-1,3,2-dioxaphospholane was utilized.

### Comparative Examples 3 to 5

Rechargeable lithium battery cells were manufactured in substantially the same manner as in Comparative Example 2, except that the content of silicon was changed respectively into about 5.0 wt %, 10 wt %, and 15 wt % based on the total weight of the negative active material to manufacture a negative electrode.

### Examples 2 and 3

A rechargeable lithium battery cell was manufactured in substantially the same manner as in Example 1, except that the content of silicon was changed respectively into about 5.0 wt % and about 10 wt % based on the total weight of the negative active material to manufacture a negative electrode.

### Comparative Example 6

Rechargeable lithium battery cells were manufactured in substantially the same manner as in Example 1, except that a negative electrode including no silicon was utilized.

### Example 4

A rechargeable lithium battery cell was manufactured in substantially the same manner as in Example 1, except that the content of the additive (i.e., 2-fluoro-4-methyl-1,3,2-dioxaphospholane) was changed into 3 parts by weight.

### Examples 5 and 6

Rechargeable lithium battery cells were manufactured in substantially the same manner as in Example 4, except that the content of silicon was respectively changed into about 5.0 wt % and 10 wt % based on the total weight of the negative active material.

### Comparative Example 7

A rechargeable lithium battery cell was manufactured in substantially the same manner as in Example 4, except that a negative electrode including no silicon was utilized.

### Example 7

A rechargeable lithium battery cell was manufactured in substantially the same manner as in Example 1, except that the content of the additive (i.e., 2-fluoro-4-methyl-1,3,2-dioxaphospholane) was changed into 5 parts by weight.

### Example 8 and 9

Rechargeable lithium battery cells were manufactured in substantially the same manner as Example 7, except that the content of silicon was changed respectively into about 5.0 wt % and 10 wt % based on the total weight of the negative active material.

### Comparative Example 8

A rechargeable lithium battery cell was manufactured in substantially the same manner as in Example 7, except that a negative electrode including no silicon was utilized.

With respect to each composition of the rechargeable lithium battery cells, the compositions and evaluation results for each additive (i.e., 2-fluoro-4-methyl-1,3,2-dioxaphospholane) content according to the presence and absence of silicon are shown in Table 1, the compositions and evaluation results for each silicon content according to the presence and absence of the additive (i.e., 2-fluoro-4-methyl-1,3,2-dioxaphospholane) are shown in Table 2, and relative values for comparing a degree of improvement are shown in Tables 3 and 4.

### Evaluation 1: Evaluation of Room-Temperature Charge and Discharge Cycle Characteristics

The rechargeable lithium battery cells according to Examples 1 to 9 and Comparative Examples 1 to 8 were evaluated with respect to cycle characteristics after charges and discharges, and the results are shown in Tables 1 to 3.

While the charges and discharges were conducted repeatedly for 300 cycles at a C-rate of 0.5 C in a range of 2.5 V to 4.2 V at 25° C., a capacity retention rate and a DC internal resistance (DC-IR) change of the cells were calculated according to Equations 1 and 2, and the results are shown in Tables 1 to 3.

Capacity retention rate=(capacity after 300 cycles/capacity after 1 cycle)*100 Equation 1

DCIR change rate={(DC-IR after 300 cycles−DC-IR after 1 cycle)/(DC-IR after 1 cycle)}*100 Equation 2

Evaluation 2: Evaluation of Initial Resistance and Resistance Increase Rate after High-Temperature Storage

The rechargeable lithium battery cells according to Examples 1 to 9 and Comparative Examples 1 to 8 were measured with respect to initial DC resistance (DCIR) as ΔV/ΔI (change in voltage/change in current), and after setting a maximum energy inside the battery cells each to a fully-charged state (SOC 100%) and storing them at a high temperature of 60° C. for 60 days, DC resistance of each of the cells was measured and utilized to calculate a DCIR increase rate (%) according to Equation 3, and the results are shown in Table 1.

DCIR increase rate=(DCIR after 60 days/initial DCIR)×100% Equation 3

TABLE 1

| | Additive | | | | DCIR |
|---|---|---|---|---|---|
| | (2-fluoro-4- | content | Initial | DCIR | increase |
| | methyl-1,3,2-di- | of Si | resis- | change | rate at |
| | oxaphospholane) | parti- | tance | ratio | 60° C. |
| | content (wt %) | cle(wt %) | (m Ω) | (%) | (%) |
| Comparative | 0 | 0 | 13.2 | 8.0 | 138.9 |
| Example 1 | | | | | |
| Comparative | | 1 | 13.9 | 9.2 | 141.1 |
| Example 2 | | | | | |
| Comparative | | 5 | 16.4 | 13.7 | 159.7 |
| Example 3 | | | | | |
| Comparative | | 10 | 20.3 | 22.1 | 190.0 |
| Example 4 | | | | | |
| Comparative | | 15 | 26.7 | 31.9 | 223.6 |
| Example 5 | | | | | |
| Comparative | 0.1 | 0 | 12.5 | 7.5 | 134.7 |
| Example 6 | | | | | |
| Example 1 | | 1 | 13.1 | 8.7 | 132.6 |
| Example 2 | | 5 | 15.9 | 13.2 | 150.1 |
| Example 3 | | 10 | 19.5 | 21.4 | 176.7 |
| Comparative | 3 | 0 | 10.7 | 6.3 | 111.1 |
| Example 7 | | | | | |
| Example 4 | | 1 | 11.5 | 7.6 | 114.3 |
| Example 5 | | 5 | 13.9 | 11.1 | 126.2 |
| Example 6 | | 10 | 16.6 | 18.3 | 157.7 |
| Comparative | 5 | 0 | 12.3 | 7.4 | 126.4 |
| Example 8 | | | | | |
| Example 7 | | 1 | 13.1 | 8.4 | 129.8 |
| Example 8 | | 5 | 14.9 | 12.2 | 140.5 |
| Example 9 | | 10 | 18.3 | 19.4 | 169.1 |

Referring to Table 1, compared with a group of devices without the additive according to embodiments of the present disclosure (e.g., without 2-fluoro-4-methyl-1,3,2-dioxaphospholane) (Comparative Examples 1 to 5), each of a group of devices having an additive (2-fluoro-4-methyl-1,3,2-dioxaphospholane) content of 0.1 wt % (Comparative Example 6, Examples 1 to 3), a group of devices having an additive (2-fluoro-4-methyl-1,3,2-dioxaphospholane) content of 3 wt % (Comparative Example 7, Examples 4 to 6), and a group of devices having an additive (2-fluoro-4-methyl-1,3,2-dioxaphospholane) content of 5 wt % (Comparative Example 8 and Examples 7 to 9) at the same content of Si particle exhibited improved resistance characteristics (an initial resistance, a DCIR change rate, a DCIR increase rate).

In other words, when the additive content was increased under the same Si content, the initial resistance, DCIR change rate, and DCIR increase rate decreased.

TABLE 2

| | content | Additive | capacity |
|---|---|---|---|
| | of Si | (2-fluoro-4-methyl- | retention at |
| | particle | 1,3,2-dioxaphospholane) | room-temperature |
| | (wt %) | content (wt %) | @ 300 cycle (%) |
| Comparative | 1 | 0 | 70.7 |
| Example 2 | | | |
| Example 1 | | 0.1 | 75.6 |
| Example 4 | | 3 | 82.7 |
| Example 7 | | 5 | 77.8 |
| Comparative | 5 | 0 | 62.3 |
| Example 3 | | | |
| Example 2 | | 0.1 | 64.8 |
| Example 5 | | 3 | 74.8 |
| Example 8 | | 5 | 67.9 |
| Comparative | 10 | 0 | 54.9 |
| Example 4 | | | |
| Example 3 | | 0.1 | 58.2 |
| Example 6 | | 3 | 63.7 |
| Example 9 | | 5 | 57.9 |
| Comparative | 15 | 0 | 50.4 |
| Example 5 | | | |

TABLE 3

| Content | Comparison by additive | capacity |
|---|---|---|
| of Si | (2-fluoro-4-methyl- | retention at |
| particle | 1,3,2-dioxaphospholane) | room-temperature |
| (wt %) | content | (%) |
| 1 | Comparative Example 2 | 100 |
| | Example 1 | 107.0 |
| | Example 4 | 117.0 |
| | Example 7 | 110.0 |
| 5 | Comparative Example 3 | 100 |
| | Example 2 | 104.0 |
| | Example 5 | 120.0 |
| | Example 8 | 109.0 |
| 10 | Comparative Example 4 | 100 |
| | Example 3 | 106.0 |
| | Example 6 | 116.0 |
| | Example 9 | 105.5 |

Table 3 shows relative values for comparing a relative degree in improvement of capacity retention at room temperature of the compositions including the additive (e.g., 2-fluoro-4-methyl-1,3,2-dioxaphospholane) with that of the compositions including no additive.

Referring to Tables 2 and 3, when the Si—C composite was included with the additive according to the present disclosure, compared with when the additive (2-fluoro-4-methyl-1,3,2-dioxaphospholane) was not added, capacity retention increased, as the content of the 2-fluoro-4-methyl-1,3,2-dioxaphospholane increased.

Referring to Tables 1 to 3, as the Si—C composite was included, the cells equally maintained high capacity retention, and simultaneously or concurrently, when the additive represented by Chemical Formula 1 according to the present disclosure was included with Si—C composite, compared with when the additive represented by Chemical Formula 1 was not included, an increase in resistance (an initial resistance increase rate, a DCIR change rate, and a DCIR increase rate at a high-temperature storage) according to an increase in the content of Si particles decreased, but capacity retention increased, and accordingly, trade-off characteristics caused by a side reaction due to the usage of the Si—C composite were complementarily improved.

As a result, when an electrolyte solution including the additive according to embodiments of the present disclosure was utilized with a negative electrode including Si—C composite, resistance characteristics and cycle-life characteristics were simultaneously or concurrently improved.

Accordingly, the rechargeable lithium battery cell according to an example embodiment of the present disclosure realized excellent cycle characteristics due to improved electrolyte solution impregnation properties and in addition, improved high-temperature stability due to reduced resistance after the high-temperature storage.

As used herein, the singular forms “a”, “an” and “the” are intended to include the plural forms as well, unless the context clearly indicates otherwise.

As used herein, the term “and/or” includes any and all combinations of one or more of the associated listed items. Throughout the disclosure, the expression, such as “at least one of a, b or c”, “at least one selected from a, b, and c”, “at least one selected from the group consisting of a, b, and c”, etc., indicates only a, only b, only c, both (e.g., simultaneously) a and b, both (e.g., simultaneously) a and c, both (e.g., simultaneously) b and c, all of a, b, and c, or variation(s) thereof.

The use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims, and equivalents thereof.

### DESCRIPTION OF SYMBOLS

100: rechargeable lithium battery
112: negative electrode
113: separator
114: positive electrode
120: battery case
140: sealing member

What is claimed is:

1. A rechargeable lithium battery, comprising
a positive electrode comprising a positive active material;
a negative electrode comprising a negative active material; and
an electrolyte solution comprising a non-aqueous organic solvent, a lithium salt, and an additive,
wherein the negative active material comprises a silicon (Si) composite, and
the additive comprises a compound represented by Chemical Formula 1: 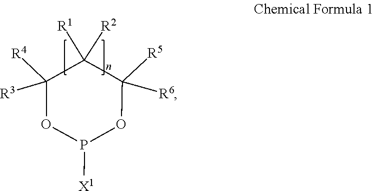
wherein, in Chemical Formula 1,
X¹ is a fluoro group (—F), a chloro group (—Cl), a bromo group (—Br), or an iodo group (—I),
R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is 0 or 1.

2. The rechargeable lithium battery of claim 1, wherein
the compound represented by Chemical Formula 1 is represented by Chemical Formula 1A or Chemical Formula 1B: 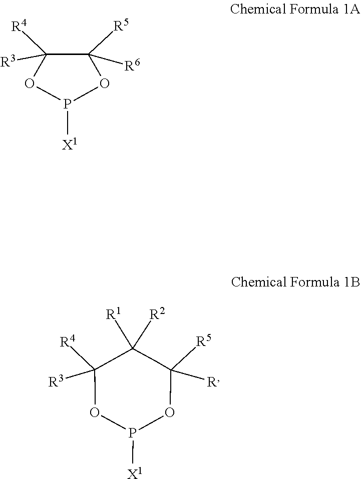
wherein, in Chemical Formula 1A and Chemical Formula 1B,
X¹ is a fluoro group (—F), a chloro group (—Cl), a bromo group (—Br), or an iodo group (—I), and
R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

3. The rechargeable lithium battery of claim 2, wherein in Chemical Formula 1A and Chemical Formula 1B,
R³ and R⁴ are each hydrogen, and
at least one selected from among R¹, R², R⁵, and R⁶ is a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

4. The rechargeable lithium battery of claim 1, wherein
the compound represented by Chemical Formula 1 is about 0.1 parts by weight to about 10 parts by weight in amount based on 100 parts by weight of the electrolyte solution.

5. The rechargeable lithium battery of claim 1, wherein
the compound represented by Chemical Formula 1 is at least one selected from compounds of Group 1:

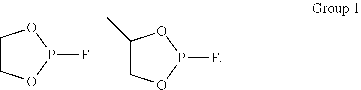

6. The rechargeable lithium battery of claim 1, wherein
the additive further comprises at least one other additive selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

7. The rechargeable lithium battery of claim 1, wherein
the Si composite comprises a core comprising Si-based particles and an amorphous carbon coating layer.

8. The rechargeable lithium battery of claim 7, wherein
the core comprising the Si-based particles and an amorphous carbon.

9. The rechargeable lithium battery of claim 8, wherein
the Si-based particles comprises at least one selected from among Si particles, Si—C composite, SiOₓ (0<x≤2), and a Si alloy, and the Si—C composite comprises Si particles and a crystalline carbon.

10. The rechargeable lithium battery of claim 8, wherein
a void is included in a center portion of the core.

11. The rechargeable lithium battery of claim 10, wherein
a radius of the center portion corresponds to about 30% to about 50% of a radius of the negative active material, and
an average particle diameter of the Si-based particles is about 10 nm to about 200 nm.

12. The rechargeable lithium battery of claim 10, wherein
the center portion does not include any amorphous carbon, and the amorphous carbon is present only in a surface portion of the negative active material.

13. The rechargeable lithium battery of claim 9, wherein
the negative active material further comprises graphite.

14. The rechargeable lithium battery of claim 9, wherein
the amorphous carbon comprises soft carbon, hard carbon, a mesophase pitch carbonized product, calcined coke, or a combination thereof.

15. The rechargeable lithium battery of claim 1, wherein
the positive active material comprises at least one lithium composite oxide represented by Chemical Formula 3:
LiₓM¹_{y}M²_{z}M³_{1-y-z}O₂₋ₐXₐ Chemical Formula 3
wherein, in Chemical Formula 3,
0.5≤x≤1.8, 0≤a≤0.05, 0≤y≤1, 0≤z≤1, 0≤y+z≤1, M¹, M², and M³ are each independently selected from the group consisting of Ni, Co, Mn, Al, B, Ba, Ca, Ce, Cr, Fe, Mo, Nb, Si, Sr, Mg, Ti, V, W, Zr, La, and a combination thereof, and X is at least one element selected from the group consisting of F, S, P, and Cl.

16. The rechargeable lithium battery of claim 15, wherein
in Chemical Formula 3, 0.8≤y≤1, 0≤z≤0.2, and M¹ is Ni.
